(19) United States
(12) Patent Application Publication
(10) Pub. No.: US 2001/0007204 A1
(43) Pub. Date: Jul. 12, 2001

(54) Method of and apparatus for monitoring and regulating the speeds of rotary parts in transmissions and the like

(76) Inventor: Josef Glosmann, Hamburg (DE)

Correspondence Address: VENABLE, P.O. Box 34385, Washington, DC, 20043-9998, US

(21) Appl. No.: 09/757,626

(22) Filed: Jan. 11, 2001

(30) Foreign Application Priority Data
Jan. 11, 2000 (DE) 100 00 715.5

(51) Int. Cl. G01N 19/00

(52) U.S. Cl. 73/7

(57) ABSTRACT

A driver gear transmits torque to a continuously driven gear by way of a toothed belt, and the driven gear transmits torque to an intermittently driven pulley for an endless conveyor which carries pockets for arrays of cigarettes in a packing machine. The extent of wear at least upon the belt is ascertained by a first signal generator which monitors the angular velocity of the driver gear, and the actual speed of the driven gear is ascertained by a second signal generator. The thus obtained signals are processed into signals denoting the desirability to arrest the prime mover for the driver gear and/or displaying and/or otherwise indicating, such as signalling, the extent of wear upon the belt.

### CROSS-REFERENCE TO RELATED CASES

The present application claims the priority of commonly owned German patent application Serial No. 100 00 715.5 filed Jan. 11, 2000. The disclosure of the above-referenced German patent application, as well as that of each US and foreign patent and patent application identified in the specification of the present application, is incorporated herein by reference.

### BACKGROUND OF THE INVENTION

The present invention relates to improvements in methods of and in apparatus for monitoring and regulating the speeds of moving parts in motion transmitting systems, such as in belt, chain or analogous types of tansmissions. More particularly, the invention relates to improvements in methods of and in apparatus for ascertaining and compensating for or indicating the presence of wear upon one or more constituents or components in a machine or production line wherein at least one driving component transmits motion to one or more driven components. Methods and apparatus of the above outlined character can be resorted to with advantage in various types of mass producing machines or production lines which are designed to turn out smokers' products.

In many types of machines or production lines (hereinafter mostly referred to as machines for short), the driving and/or the driven parts must be moved (such as rotated, orbited or otherwise advanced along a straight, arcuate or endless path) at a very high speed and/or with minimal or zero deviation from a prescribed route, course or track. This necessitates the utilization of driving units which can transmit motion with a very high degree of accuracy. On the other hand, such mode of transmitting motion from one or more driving components to one or more driven components invariably necessitates highly accurate guidance of such components, and this often involves frictional, rolling or other types of contact with guiding, confining, direction changing and other restraining parts which, in turn, results in at least some wear, i.e., a phenomenon which is bound to affect the accuracy of speed, direction of movement and/or other parameters of the driving and/or driven components. The extent of wear can be gradual or it can fluctuate within a wide range, e.g., when the driving and/or driven components are subjected to stresses, loads or analogous influences which vary, even within a rather narrow range.

Extensive wear or, for that matter, any wear entails departures from the prescribed speeds and/or paths of the driving and/or driven components so that such components must be inspected, repaired and/or replaced at certain intervals which, in turn, necessitates timely detection of wear and/or of consequences of wear in order to avoid the making of long series of rejects, e.g., plain or filter cigarettes or other types of smokers' products and/or accumulations (such as so-called soft or hinged-lid cigarette packs) of such products. Timely detection of wear-induced defects renders it possible to undertake corrective measures in good time before the quality of the products drops below an acceptable value.

U.S. Pat. No. 5,345,954 (granted Sep. 13, 1994 to Dell'osso et al. for “METHOD OF CONTROLLING AND REGULATING THE TRAVELING SPEED OF A CONTINUOUS CIGARETTE ROD ON A CIGARETTE MANUFACTURING MACHINE”) discloses a method of regulating the speed of a continuous tobacco-containing rod which moves lengthwise into the range of a so-called cutoff designed to sever the leader of the advancing rod at regular intervals to thus form a file or row of cigarettes of selected length. The patented method includes the steps of (a) continuously generating a first signal which denotes the diameter of a pulley serving to drive an endless belt (called garniture) which advances the rod toward the cutoff, (b) generating a second signal which is indicative of the desired speed of the rod, and (c) comparing the first and second signals. The accuracy of such method has a relatively low upper limit and, furthermore, the patented method does not take into consideration all such parameters which can influence the quality of the ultimate products, for example, the wear and/or other undesirable influences upon the cutoff.

### OBJECTS OF THE INVENTION

An object of the present invention is to provide a novel and improved method of monitoring and regulating the speeds and/or related parameters of driving and/or driven components in a transmission or an analogous motion transmitting system with a heretofore unachievable degree of accuracy.

Another object of the invention is to provide a method which renders it possible to compensate for or to counteract the effects of wear upon the driving and/or driven parts of a belt, band or chain transmission having rotary driving and driven parts with a degree of accuracy higher than that achievable by resorting to heretofore known methods.

A further object of the invention is to provide a novel and improved method of operating a packing machine for cigarettes or other types of smokers' products.

Another object of the invention is to provide a method which can be practiced by resorting to relatively simple, compact, versatile, inexpensive and reliable apparatus.

An additional object of the invention is to provide an apparatus which can be put to use in existing machines and/or production lines wherein a certain amount of wear upon one or more parts is likely to cause the making of large numbers of rejects to ensure timely detection of undesirable extent of wear.

Still another object of the invention is to provide a novel and improved drive for an intermittently operated endless belt, chain or band conveyor.

A further object of the invention is to provide a novel and improved combined speed monitoring, regulating and indicating system for use in cigarette packing and/or many other types of machines.

Another object of the invention is to provide the aforementioned combined speed monitoring, regulating and indicating system with an arrangement for indicating the stages or the extent of deviation of actual operation of a drive for a conveyor or the like from the desired or optimum operation.

An additional object of the invention is to provide a novel and improved arrangement for coupling a prime mover with an intermittently driven conveyor.

### SUMMARY OF THE INVENTION

One feature of the present invention resides in the provision of a method of monitoring the extent of wear upon moving parts in a motion transmitting system (such as a belt transmission) wherein at least one mobile first component (such as a gear and a toothed belt which is trained over the gear) drives at least one mobile second component (such as a gear which receives motion from the aforementioned belt). The improved method comprises the steps of generating first signals which denote at least one first parameter characteristic of the at least one first component and varying as a function of the extent of wear upon the at least one first component, generating second signals which denote at least one second parameter characteristic of at least one movement-related condition of the at least one second component, and comparing the first and second signals.

The motion transmitting system can form part of a machine for the processing of smokers' products (e.g., of a machine for packing cigarettes, cigarillos, cigars or other rod-shaped products of the tobacco processing industry).

The method can further comprise the step of arresting at least one of the first and second components when the comparing step results in the detection of wear-induced differences existing between the first and second signals and exceeding a predetermined (acceptable) range of differences. Such method can further comprise the step of generating at least one additional (such as a visible and/or audible) signal when the comparing step results in the detection of wear-induced differences within the aforementioned predetermined (acceptable) range of differences.

Otherwise stated, the improved basic method can further comprise the step of generating at least one additional signal when the comparing step results in the detection of a wear-induced difference existing between the first and second signals and at least matching a preselected difference. The at least one additional signal can constitute a visually detectable alarm signal. Alternatively, or in addition to the generation of a visually detectable alarm signal, the method can include the step of displaying the extent of wear-induced difference between the first and second signals.

The at least one second component of the motion transmitting system is or can constitute a continuously driven component, and the method can comprise an additional step of utilizing the at least one second component for transmission of motion to at least one intermittently driven third component.

If the first and/or second component is or includes a rotary component, the respective signal generating step can include generating signals which denote the angular velocity of the rotary component.

At least one of the first and second components can include or constitute a rotary gear, e.g., a spur gear.

Another feature of the present invention resides in the provision of an apparatus for monitoring the extent of wear upon moving parts in a motion transmitting system (e.g., in a belt transmission) wherein at least one mobile first component (such component can include a gear and a toothed belt which is trained over the gear) transmits motion to at least one mobile second component (such second component can include a gear which is driven by the aforementioned toothed belt) and is subject to progressing wear as a result of transmission of motion to the at least one second component. The improved apparatus comprises means for generating first signals denoting at least one first parameter which is characteristic and varies as a function of the extent of wear upon the at least one first component, means for generating second signals denoting at least one parameter which is characteristic of at least one movement-related condition of the at least one second component, and means for processing the first and second signals.

The motion transmitting system can form part of or can cooperate with a machine for the processing of smokers' products, e.g., the aforementioned packing machine for cigarettes or other rod-shaped products of the tobacco processing industry.

At least one of the first and second components can include a rotary member, e.g., a gear (such as a spur gear).

In accordance with a presently preferred embodiment of the invention, the improved apparatus can be put to use in conjunction with a motion transmitting system wherein the at least one first component includes a first rotary component, the at least one second component includes a second rotary component, and wherein the motion transmitting system further includes an endless flexible torque transmitting element (such as the aforementioned toothed belt) which is trained over the rotary components. The rotary components can constitute gears, such as spur gears.

At least one of the signal generating means can be provided at (i.e., close to or on) the respective mobile component.

At least one of the components can include a rotary shaft and a rotary member (such as a gear) mounted on the shaft; the respective signal generating means can be mounted on the shaft.

If at least one of the mobile components includes a rotary member, the respective signal generating means can include means for monitoring the angular velocity of the rotary member.

The processing means can include means for comparing the first and second signals and for generating third signals which denote the extent of wear upon the first mobile component. As already mentioned hereinbefore, such first mobile component can include a rotary gear and a toothed belt which is trained over the gear.

The motion transmitting system can be constructed and assembled in such a way that the at least one first component serves to maintain the at least one second component in continuous motion (such as rotary motion) and such system can further comprise at least one additional mobile component which receives intermittent motion from the (continuously driven) at least one second mobile component.

The novel features which are considered as characteristic of the invention are set forth in particular in the appended claims. The improved apparatus itself, however, both as to its construction and the modes of assembling, installing and operating the same, together with numerous additional important and advantageous features and attributes thereof, will be best understood upon perusal of the following detailed description of certain presently preferred specific embodiments with reference to the accompanying drawing.

### BRIEF DESCRIPTION OF THE DRAWINGS

FIG. 1 is a fragmentary elevational view of a belt transmission which transmits motion to an intermittently driven conveyor in a cigarette packing machine, and a diagrammatic view of an apparatus which embodies one form of the present invention and is designed to monitor the extent of wear upon one or more mobile components of the transmission; and

FIG. 2 is a flow diagram of various steps according to one presently preferred embodiment of the improved method.

### DESCRIPTION OF PREFERRED EMBODIMENTS

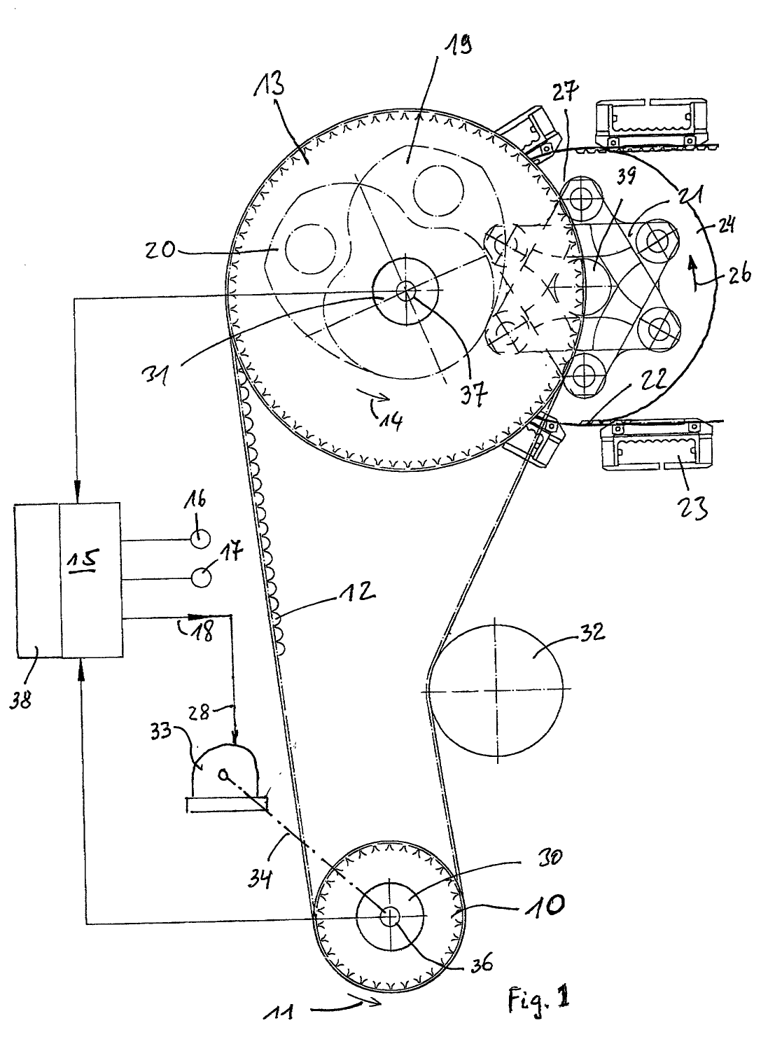

The apparatus which is illustrated in FIG. 1 controls a system serving to transmit motion from a prime mover 33 (such as a variable-speed electric motor) to an intermittently driven endless belt, chain or band conveyor carrying a series of equidistant receptacles or pockets 23. The pockets 23 can perform functions corresponding to those of the pockets shown and described in commonly owned copending patent application Ser. No. ______ filed ______, 2000 by Hartmut Meis for “METHOD OF AND APPARATUS FOR ACCUMULATING AND MANIPULATING ARRAYS OF CIGARETTES AND THE LIKE”. Reference may also be had to U.S. Pat. No. 4,471,866 granted Sep. 18, 1984 to Erdmann et al. for “APPARATUS FOR ASSEMBLING ARRAYS OF CIGARETTES IN PACKING MACHINES”. A packing machine which employs a conveyor corresponding to the conveyor 22 shown in FIG. 1 of the present application is known as COMPAS 500 and is distributed by the assignee of the present application.

The purpose of the system (hereinafter called transmission) which receives motion from the prime mover 33 and transmits motion to the conveyor 22 (and hence to the pocket 23) is to convert uninterrupted rotary motion of the output shaft 34 of the prime mover 33 into intermittent angular movement of a driver pulley or sheave 24 for the endless conveyor 22. The transmission comprises a mobile first component 10 (which is a spur gear rotatable about the axis of the output shaft 34 of the prime mover 33 or about the axis of a shaft 36 receiving torque from the shaft 34), a mobile second component 13 (shown in the form of a spur gear rotatable about the axis of a shaft 37 which is parallel to the shaft 36), an endless flexible element 12 (here shown as a toothed belt) which is trained over the gears 10, 13, a tensioning idler roller or wheel 32 which bears upon the external surface of the belt 12, and a mechanism which converts uninterrupted rotary motion of the gear 13 into intermittent motion of the pulley 24. The directions of rotation of the gears 10, 13 and pulley 24 are respectively indicated by the arrows 11, 14 and 26.

The illustrated rotary motion converting mechanism comprises two angularly offset cams 19, 20 which are coaxial with and are driven by the shaft 37 of the driven gear 13, and a standard star wheel 21 affixed to and coaxial with the shaft 39 of the pulley 24. The six equidistant prongs of the star wheel 21 carry roller followers 27 which are entrained by the oncoming lobes of the cams 19, 20 when the gear 13 receives continuous rotary motion from the output shaft 34 of the prime mover 33 by way of the gear 10 and toothed belt 12. The just described rotary motion converting mechanism can be replaced with any other suitable mechanism without departing from the spirit of the present invention.

The conveyor 22 can be utilized in a single-track or in a multiple-track packing machine (reference may be had again to the aforementioned copending patent application Ser. No. ______ of Meis).

The improved apparatus serves to monitor the extent of wear upon at least one of the gears 10, 13 and belt 12 as well as to carry out certain remedial and/or other undertakings when the extent of wear reaches at least one predetermined stage. The apparatus which is actually illustrated in FIG. 1 comprises a signal processing control unit 15; a first signal generator 30 which, in the illustrated embodiment, transmits signals denoting at least one first parameter that varies as a function of the extent of wear upon the gear 10 and/or a part (i.e., the belt 12) which is in direct contact therewith; and a second signal generator 31 denoting at least one parameter which is characteristic of at least one movement-related condition of the gear 13.

The illustrated signal generators 30, 31 are designed to respectively generate signals denoting the angular velocities and/or angular movements of the shafts 36, 37 (i.e., of the gears 10, 13). Such signals are transmitted to the corresponding inputs of the control unit 15 which preferably continuously processes the signals to ascertain the difference(s) between certain characteristics (e.g., intensities) of the first and second signals and generates additional signals denoting the ascertained differences. The additional signals which are transmitted by the control unit 15 can constitute signals denoting the results of comparison of first and second signals with each other and/or the results of comparison of ascertained first and second signals with predetermined reference signals.

For example, the first and/or second signals can be compared with predetermined reference signals to ascertain the extent of deviation of signals transmitted by the signal generator 30 and/or 31 from a predetermined reference value. In accordance with a presently preferred embodiment, the control unit 15 can be set up to ascertain the difference between the characteristics of the signals being transmitted by the signal generators 30, 31 by taking into consideration the ratio of the transmission including the gears 10, 13 and the belt 12. The illustrated transmission is assumed to operate with a ratio of approximately 1:2.37, i.e., each angular displacement of the gear 10 through 90° should result in an angular displacement of the gear 13 through an angle of about 37.98°. This is the desired or preselected or optimum transmission ratio.

If the departure of the actual (ascertained) ratio from the desired or optimum ratio reaches a first preselected value, the illustrated control unit 15 is set up to transmit an output signal which causes a first indicating or warning device 16 to transmit a first detectable signal (e.g., a yellow signal or a tone of a first intensity). If the departure of the ascertained actual ratio from the desired or optimum ratio reaches a second predetermined value, the illustrated control unit 15 is caused to actuate a second indicating or warning device 17 which is designed to generate a second detectable signal (e.g., a red light and/or a tone or sound of a higher second intensity). Each signal being generated by the control unit 15 is indicative of a certain extent of wear upon at least one of the parts 10, 12 and 13.

If the extent of wear upon the part 10, 12 and/or 13 rises to an even higher value, the illustrated control unit 15 is designed to actuate a further device 18 which is operatively connected with and can arrest or decelerate the prime mover 33 or disconnect the prime mover from the shaft 36 of the driver gear 10. It is clear that the control unit 15 can be constructed, assembled and programmed to actuate only one of the devices 16, 17, or only the devices 16, 17, or only the device 18. Furthermore, the control unit 15 preferably comprises or cooperates with a suitable display 38 which can furnish visually and/or otherwise detectable information denoting the extent of wear upon the transmission in lieu of or in addition to that adapted to be furnished by the device 16, 17 and/or 18.

It can be readily ascertained that, when the wear upon at least one component (such as the gear 10 and/or the belt 12) progresses, the angular velocity and/or the angular displacement of the gear 13 (in comparison with that of the gear 10) decreases. As already mentioned hereinbefore, it is necessary to take into consideration the ratio of the transmission including the parts 10, 12 and 13. The wear is relatively high (i.e., pronounced) if, as in the illustrated transmission, one employs means for converting the continuous rotary movements of the driven gear 13 into intermittent angular movements of the pulley 24 (i.e., into intermittent stepwise advances of the conveyor 22 and its receptacles or pockets 23). This will be readily appreciated by bearing in mind that the stresses upon the continuously driven gear 10 and/or 13 and/or belt 12 vary stepwise as a result of intermittent rotation (including repeated acceleration and deceleration) of the star gear 21, pulley 24 and conveyor 22. The load upon (i.e., resistance to rotation of) the gear 13 fluctuates between zero or nearly zero (when the pulley 24 is at a standstill) and a substantial load during acceleration as well as during the interval following acceleration and preceding the next-following deceleration of the conveyor 22 and of the weight (including the pockets 23 and the arrays of cigarettes therein) borne by the conveyor. Such fluctuations of resistance which the gear 13 encounters as a result of its connection with the intermittently driven conveyor 22 can result in so-called knocking or chatter of the transmission.

Departures of the extent of actual intermittent movements of the conveyor 22 from desired or optimum extent can result in damage to cigarettes during introduction into the pockets 23 and/or during transfer of arrays of cigarettes from the pockets into the track or tracks of the packing machine.

It is presently preferred to assemble the improved apparatus (the illustrated apparatus includes the control unit 15, the signal generators 30, 31, the display 38, the devices 16, 17, 18 and the connection 28 between the device 18 and the prime mover 33) in such a way that the signal generators 30, 31 transmit signals denoting the angular velocities of the respective gears 10, 13, that the control unit 15 compares the characteristics of such signals, and that the device 16 and/or 17 as well as (if necessary) the device 18 is activated when the extent of difference between the signals from 30 and 31 reaches the corresponding level or threshold value.

The device 18 preferably reacts to arrest or decelerate the prime mover 33 before the transmission and/or the machine which embodies or cooperates with the transmission undergoes any damage or any appreciable damage, and before the machine begins to turn out defective products (e.g., cigarette packs). The display 38 also constitutes a presently preferred feature of the improved apparatus. It is also preferred to ensure that the device 16, 17 and/or 18 responds or reacts with at least some delay, i.e., that the improved apparatus is set up to operate with a certain range of tolerances before the difference between the characteristics of signals being transmitted to the control unit 15 by the signal generators 30, 31 suffices to initiate at least one corrective or remedial undertaking such as the generation of a visible and/or audible warning signal and/or stoppage or deceleration of the prime mover 33.

The improved method and apparatus can be resorted to in connection with the making and/or processing of various types of smokers' products and/or other types of products which renders it advisable and/or necessary to carry out corrective undertakings in response to small or minimal departures of actual mode of operation from a desired or required mode of operation, e.g., or particularly as a result of progressing wear upon one or more mobile components or parts or groups of parts. The aforedescribed novel method and apparatus can be resorted to solely as an expedient to warn the operator(s) in charge of a machine or production line, or as a safety system which can interrupt or change the rate of operation of the machine or production line in order to prevent further damage or a total breakdown and/or to reduce the number of rejects, e.g., the number of defective soft or hinged-lid packs turned out by the aforementioned COMPAS 500 or another cigarette packing machine.

Certain important advantages of the improved apparatus include its simplicity, compactness, low cost and ability to cooperate with or to be built into existing types of machines and/or production lines. Moreover, the improved apparatus can be set up in such a way that it effects a stoppage of one or more parts of a machine or production line if the remaining part or parts of the machine or production line can continue to operate satisfactorily. For example, and if the illustrated transmission is installed in or cooperates with a cigarette packing machine, a cigarette maker which normally feeds plain or filter cigarettes for admission into the pockets 23 can deliver cigarettes into a magazine while the person(s) in charge attends or attend to the work which is necessary to ensure that the device 18 remains idle upon renewed starting of the prime mover 33 or another suitable prime mover.

An advantage of the devices 16 and 17 is that they can be designed, installed and adjusted to generate signals (such as visible and/or audible signals) in good time prior to activation of the device 18 so that the attendant(s) can locate and make ready all such parts which are or which might be necessary to ensure rapid replacement of worn parts (such as the part 10, 12 and/or 13) before the control unit 15 causes the device 18 to arrest or to decelerate the prime mover 33. This renders it possible to reduce the duration of down times of the machine or production line to a minimum with attendant increase of the output. The device 16 and/or 17 can further serve to transmit appropriate warning signals to a master, to a central monitoring or regulating station and/or to another locale which is designed to control or is in charge of monitoring the operation of a group of cooperating or otherwise associated machines (such as that of a production line including a cigarette maker, a filter rod maker, a filter cigarette maker (called tipping machine), a packing machine for arrays of filter cigarettes, a cellophaning machine for cigarette packs, a carton filling machine and a carton boxing machine).

If the improved apparatus employs a display (such as that schematically shown at 38), the display is or can or should be designed to furnish information which is obtained by full consideration of all relevant factors, such as the ratio of the transmission including the gears 10, 13 and the toothed belt 12. For example, the value of one of the signals furnished by the signal generators 30, 31 can be added to or deducted from the value of the other signal or multiplied by a factor which is characteristic of the transmission ratio. It is presently preferred to employ a display (38) which can furnish a linear indication of the extent of progressing wear upon one or more relevant parts of the transmission. However, it is also possible to employ a display which is designed to furnish exponential or logarithmic information regarding the monitored extent of wear.

It has been found that the improved method and apparatus can be utilized with particular advantage if the transmission employs rotary parts such as gears, wheels, pulleys and the like. The wear upon such rotary parts of a transmission which is associated with the improved apparatus can be monitored with a high degree of accuracy and reproducibility. The utilization of a transmission which employs an endless flexible torque transmitting element (such as the presently preferred toothed belt 12) has been found to further contribute to reliability of the improved apparatus. Such torque transmitting element contributes to the transmission of torque without the generation of appreciable noise and with a high degree of predictability for long periods of time.

Another advantage of the toothed belt 12 (or of an equivalent thereof) is that it can be replaced (e.g., as a result of wear) within a very short interval of time; this contributes to a pronounced shortening of down times and hence to a higher output of the machine or production line embodying or cooperating with the conveyor 22. This is particularly important in the tobacco processing industry wherein certain recent types of machines (such as cigarette makers, filter rod makers, packing machines and many others) turn out huge quantities of products per unit of time.

The signal generators 30, 31 can be of the type known as Drehgeber ROD 426.001B distributed by HEIDENHAIN CORPORATION, 115 Commerce Drive, Schaumburg, Ill. 60173.

For example, each of the signal generators 30, 31 can be designed to complete 40,000 increments or steps per revolution of the monitored part. This corresponds to 111 measuring increments by degree. The arrangement can be such that the control unit 15 does not transmit (to the device 16, 17 and/or 18) any signals when the departure of the actual count from the desired or required count (i.e., from 40,000 increments per revolution) is in the range of ±30. In other words, this can represent the tolerance range within which the control unit 15 does not transmit any signals or is set to deactivate the devices 16, 17 and 18.

If the deviation (from 40,000 steps or increments per revolution) is within the range of ±30 and ±60 increments, the control unit 15 can be set to activate one of the devices 16, 17 or both such devices (e.g., first the device 16 and thereupon the device 17). If the deviation is in the range of between ±60 and ±90 per revolution, the control unit 15 is or can be set to activate the device 18, i.e., to arrest or to reduce the speed of the prime mover 33.

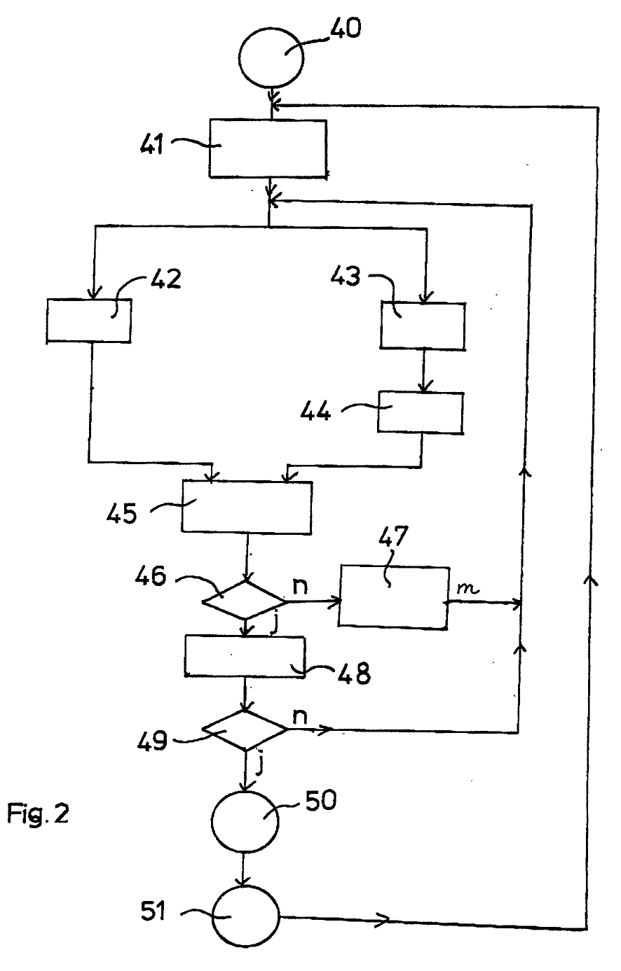

In the flow diagram of FIG. 2, the circle 40 denotes the start of operation of the improved apparatus, the signal generators 30, 31 are set or reset to zero at 41, and the box 42 denotes the starting of one (e.g., 30) of the signal generators 30, 31; such one signal generator measures increments D1. The other signal generator (31) measures increments D2 starting at 43. The value of the signal D2 furnished by the signal generator 31 is inverted at 44, i.e., such signal is provided with a negative prefix. The box 45 denotes the ascertainment of the sum of D1 and inverted D2 (this can be designated as D1-D2).

At 46, the control unit 15 ascertains whether or not D1-D2 exceeds 30. If such is not the case, the output n transmits a signal to 47 which entails the erasure of signals (if any) being then transmitted by the device 16, 17 and/or 18. The signal at the output of 47 is transmitted at m to restart the measurement at 41.

If the sum ascertained at 46 exceeds 30, i.e., if the difference between the desired or required number of increments and the actual number of increments per revolution is above 30, the output j of 46 transmits a signal to 48 which entails the generation of a (warning) signal (by 16 and/or 17).

The box 49 denotes the step of ascertaining whether or not the difference between the measurements carried out by the signal generators 30, 31 equals or exceeds 60. If such is not the case (see the output n of 49), the procedure is restarted at 41. If the difference ascertained at 49 matches or exceeds 60, the output j of 49 transmits a signal to 50 which results in the transmission of a signal to 18. The circle 51 denotes the step of replacing the (presumably worn and/or damaged) toothed belt 12 with a fresh belt. The operation of the transmission and the monitoring of the increments counted at 30, 31 can be restarted when the replacement of the previously utilized belt 12 is completed.

It is often advisable to install the signal generators (such as 30, 31 or the equivalents thereof) close to or directly on or at the monitored parts. This normally contributes to the generation of signals which more accurately reflect the monitored conditions or characteristics or parameters of the respective parts of the transmission.

The improved apparatus can be utilized with particular advantage to indicate the extent of wear (or the presence or absence of wear) upon that part or upon those parts of the transmission which transmits or transmit torque to the driven component (such as the gear 13), especially the extent of wear upon the belt 12.

Without further analysis, the foregoing will so fully reveal the gist of the present invention that others can, by applying current knowledge, readily adapt it for various applications without omitting features that, from the standpoint of prior art, fairly constitute essential characteristics of the generic and specific aspects of the above outlined contribution to the art of compensating for wear upon component parts of transmissions and the like and, therefore, such adaptations should and are intended to be comprehended within the meaning and range of equivalence of the appended claims.

What is claimed is:

1. A method of monitoring the extent of wear upon moving parts in a motion transmitting system wherein at least one mobile first component drives at least one mobile second component, comprising the steps of:
generating first signals denoting at least one first parameter which is characteristic of the at least one first component and varies as a function of the extent of wear upon the at least one first component;
generating second signals denoting at least one second parameter which is characteristic of at least one movement-related condition of the at least one second component; and
comparing said first and second signals.

2. The method of claim 1, wherein the motion transmitting system forms part of a machine for the processing of smokers' products.

3. The method of claim 1, further comprising the step of arresting at least one of the first and second components when said comparing step results in the detection of wear-induced differences existing between said first and second signals and exceeding a predetermined range of differences.

4. The method of claim 3, further comprising the step of generating at least one additional signal when said comparing step results in the detection of wear-induced differences within said predetermined range of differences.

5. The method of claim 1, further comprising the step of generating at least one additional signal when said comparing step results in the detection of a wear-induced difference existing between said first and second signals and at least matching a preselected difference.

6. The method of claim 5, wherein said at least one additional signal is a visually detectable alarm signal.

7. The method of claim 5, further comprising the step of displaying the extent of wear-induced difference between said first and second signals.

8. The method of claim 1, wherein the at least one second component is a continuously driven component and further comprising the step of utilizing the at least one second component for transmission of motion to at least one intermittently driven third component.

9. The method of claim 1, wherein at least one of the first and second components is a rotary component and the respective signal generating step includes generating signals denoting the angular velocity of the rotary component.

10. The method of claim 1, wherein at least one of the first and second components includes a rotary gear.

11. Apparatus for monitoring the extent of wear upon moving parts in a motion transmitting system wherein at least one mobile first component transmits motion to at least one mobile second component and is subject to progressing wear as a result of such transmission of motion, comprising:
means for generating first signals denoting at least one first parameter which is characteristic and varies as a function of the extent of wear upon the at least one first component;
means for generating second signals denoting at least one parameter which is characteristic of at least one movement-related condition of the at least one second component; and
means for processing said first and second signals.

12. The apparatus of claim 11, wherein the motion transmitting system forms part of a machine for the processing of smokers' products.

13. The apparatus of claim 11, wherein at least one of the first and second components includes a rotary member.

14. The apparatus of claim 13, wherein said rotary member includes a gear.

15. The apparatus of claim 11, wherein said at least one first component includes a first rotary component, said at least one second component includes a second rotary component and the motion transmitting system further includes an endless flexible torque transmitting element trained over said rotary components.

16. The apparatus of claim 15, wherein said rotary components are gears and said endless flexible element includes a toothed belt.

17. The apparatus of claim 11, wherein at least one of said signal generating means is provided at the respective mobile component.

18. The apparatus of claim 11, wherein at least one of said components includes a rotary shaft and a rotary member mounted on said shaft, the respective signal generating means being mounted on said shaft.

19. The apparatus of claim 11, wherein at least one of said components includes a rotary member and the respective signal generating means includes means for monitoring the angular velocity of said rotary member.

20. The apparatus of claim 11, wherein said processing means comprises means for comparing said first and second signals and for generating third signals denoting the extent of wear upon said first mobile component.

21. The apparatus of claim 20, wherein said first mobile component includes a rotary gear and a toothed belt trained over said gear.

22. The apparatus of claim 11, wherein said at least one first component is arranged to maintain said at least one second component in continuous motion and the motion transmitting system further comprises at least one additional mobile component receiving intermittent motion from said at least one second mobile component.
